(19) United States
(12) Patent Application Publication
(10) Pub. No.: US 2017/0293938 A1
(43) Pub. Date: Oct. 12, 2017

(54) INTERACTIVE COMPETITIVE ADVERTISING COMMENTARY

(71) Applicant: T-Mobile USA, Inc., Bellevue, WA (US)

(72) Inventors: Deborah Escher, Seattle, WA (US); Michael Miller, Seattle, WA (US)

(73) Assignee: T-Mobile USA, Inc.

(21) Appl. No.: 15/482,573

(22) Filed: Apr. 7, 2017

Related U.S. Application Data
(60) Provisional application No. 62/320,340, filed on Apr. 8, 2016.

(51) Int. Cl. G06Q 30/02; H04N 5/232; G06K 9/00; G06K 9/34; H04N 5/445; G06T 7/90

(52) U.S. Cl. CPC G06Q 30/0267; H04N 5/44504; G06T 7/90; G06K 9/00671; G06K 9/00255; G06K 9/00302; G06K 9/00288; G06K 9/344; H04N 5/23222; G06T 2207/10024; G06T 2200/24; G06F 3/04842

(57) ABSTRACT

A sponsoring brand may provide an application for mobile devices that allows users to take pictures of competitor advertisements and that provides responses to any assertions found in the competitor advertisements. The application may instruct a user to capture an image of an advertisement. Various types of detection and/or recognition components may be used to analyze the image to detect and recognize assertions, logos, and other objects or characteristics. The application then displays the image, and also displays responses or commentary relating to any assertions, logos, objects, or characteristics. The responses may point out errors, exaggerations, misstatements, deceptive statements, etc., and may also contain information that promotes the sponsoring brand.

### CROSS-REFERENCE TO RELATED APPLICATION

This application claims priority to a co-pending, commonly owned U.S. Provisional Patent Application No. 62/320,340 filed on Apr. 8, 2016, and titled “Misrepresentation Detector,” which is herein incorporated by reference in its entirety.

### BACKGROUND

Consumers increasingly use smartphones as integral parts of their lives. Smartphones are used for things such as lists, navigational guidance, photography, planning, communications, shopping, research, etc.

Many smartphone applications include advertisements. Websites, which are often accessed from mobile devices, also contain advertisements. However, as consumers are exposed to more and more advertising, there is continuing interest in finding different ways to utilize the capabilities of smartphones and other mobile devices to provide interesting and engaging advertising and promotions.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating an example system for providing commentary and other media relating to advertisements seen by a user of a mobile device.

FIG. 2 is an example of a graphical user interface (GUI) that may be implemented by the system of FIG. 1 to display advertisement commentary.

FIGS. 3A, 3B, 3C, and 3D show another example of a GUI that may be implemented by the system of FIG. 1 to display advertisement commentary.

FIG. 4 is a flow diagram illustrating an example method of presenting commentary and other media relating to advertisements seen by a user of a mobile device.

FIG. 5 is a flow diagram illustrating another example method of presenting commentary and other media relating to advertisements seen by a user of a mobile device.

FIG. 6 is a flow diagram illustrating an example method of presenting advertisement commentary to a user.

FIG. 7 is a block diagram of an example mobile device that may be configured to implement certain of the techniques described herein.

FIG. 8 is a block diagram of an example computing device that may be configured to implement certain of the techniques described herein.

### DETAILED DESCRIPTION

The described implementations provide devices, systems, and methods for interactively displaying promotional information and other information to a user of a mobile device. In certain described embodiments, an application provided by a sponsoring brand is installed on a mobile device. The application interacts with a user, instructing the user to take a picture of a printed advertisement or any other type of visual advertising material. After the user has taken a picture or otherwise specified an image for analysis, the application analyzes the image to detect assertions made in the pictured advertisement, and to respond to such assertions. For example, the application may detect assertions that are in the form of slogans, statements, or claims, and might respond with contradictory or questioning textual statements. Similarly, the application may detect a logo that is associated with a product or brand, and in response present information that relates to the product or brand, or present information that is favorable to the sponsoring brand.

In some cases, for example, the application might respond to an assertion by displaying an image of the advertisement containing the assertion, and also displaying a textual response within the image near or over the detected assertion. The response may refute the assertion, or may point out any deceptive claims or misleading information conveyed by the assertion. In addition, or alternatively, the response may positively promote the sponsoring brand and/or a product of the sponsoring brand. Responses provided in this way may be entertaining, informative, or humorous in order to engage the user.

In addition to responding to advertising assertions or statements, the application may be configured to provide responses to pictured text and objects other than advertising. For example, the application may be configured to recognize a celebrity face and to provide commentary that is somehow related to that celebrity. This type of information may also be designed to present the sponsoring brand in a favorable light. The same types of actions may be taken with respect to other objects such as landmarks, animals, vehicles, etc.

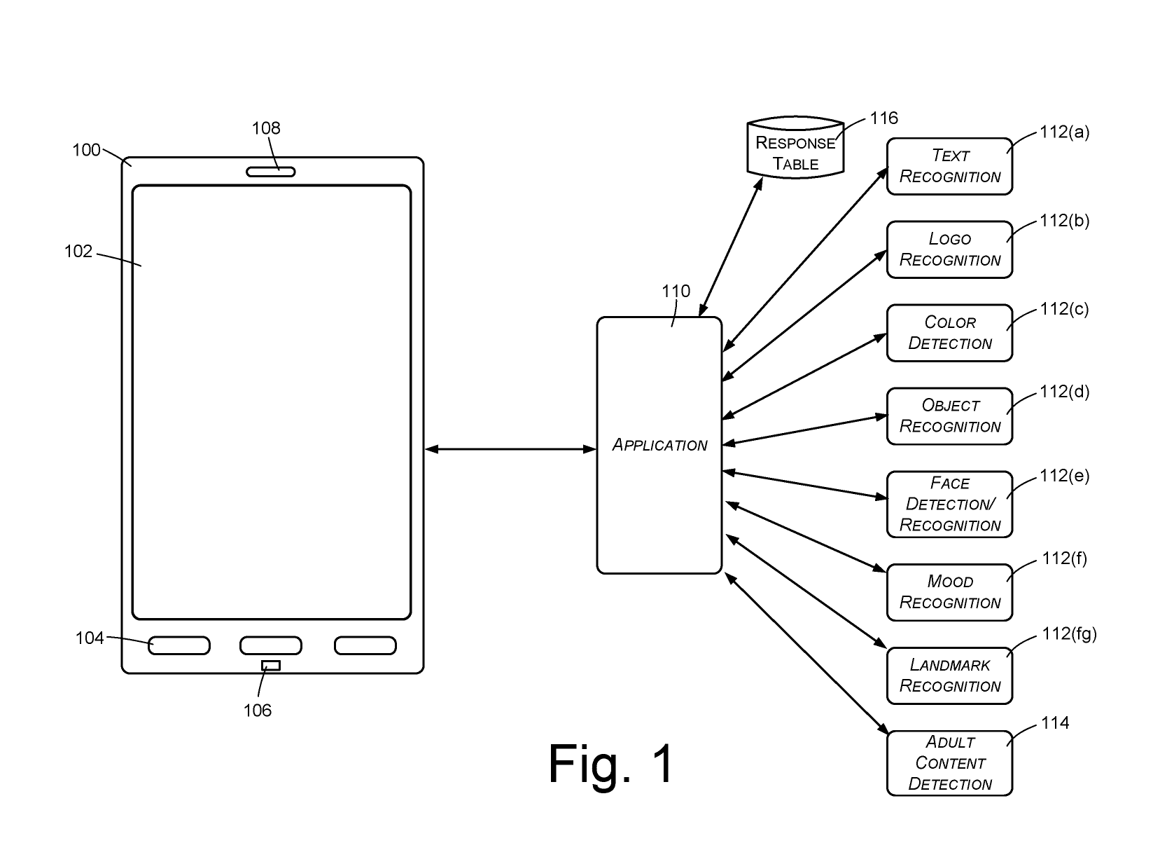

FIG. 1 shows a mobile device 100 that has a touch-sensitive display 102 upon which a graphical user interface can be displayed. In FIG. 1, the mobile device 100 is shown as a smartphone. More generally, however, the mobile device 100 may comprise any type of device, not limited to a telecommunications device. For example, the mobile device 100 may comprise a tablet computer, a personal digital assistant (PDA), a wearable device, a portable computer, etc. Some embodiments may also work in conjunction with non-mobile devices such as desktop computers, smart TVs, gaming consoles, and so forth.

The mobile device 100 may have wireless communication capabilities, which may comprise cellular communication capabilities and/or non-cellular networking capabilities such as Wi-Fi. The device may additionally or alternatively have Ethernet or other wired networking capabilities.

The mobile device 100 has user interface components that are typical of personal devices, such as buttons 104, a microphone 106, a speaker 108, and a camera (not shown in FIG. 1). A user may interact with the device 100 by voice, by pressing the buttons 104, and/or by touching the touch-sensitive display 102.

The device 100 is configured by way of an application 110 to analyze advertisements and other materials in order to detect and respond to assertions regarding a product and/or product brand. The application 110 may be an application that is installed on the mobile device 100 or may comprise a web application that runs on one or more Internet-accessible servers, and that is accessed by a client application running on the device 100. In some embodiments, the application 110 may comprise a combination of a client application that is installed on and runs on the device 100 and a server application that runs on one or more servers and that is accessible by way of a wide-area network such as the Internet (not shown). For purposes of discussion, the application 110 will be referred to as a single component, with it being understood that elements of the described functionality attributed to the application 110 can in actual embodiment be distributed in different ways across different hardware and software elements.

Generally, the application 110 is configured to analyze an image of an advertisement in order to detect words, phrases, and/or objects that are within the image and to display responses or other commentary relating to the detected words, phrases, and/or objects. In certain implementations, the application 110 may be provided by what will be referred to as a sponsoring brand in order to detect and refute assertions regarding one or more competitive products or brands, as well as to promote the sponsoring brand and its products.

In operation, the application 110 interacts with a user through the GUI of the device 100 to step the user through a process of obtaining an image of an advertisement or other visual material and of submitting the image for analysis. For example, the application 110 may generate a GUI pane instructing the user to take a picture of an advertisement for a competitor's product using the camera of the device 100. Once the picture has been taken, it is analyzed to detect any assertions that are made by or within the advertisement. For example, the application 110 may perform text recognition on the picture to detect a keyword or phrase in the picture, and then compare the keyword or phrase to a list of known competitor keywords and phrases. The application 110 may additionally look up a predefined response to the keyword or phrase and display it within the GUI 104. In some cases the response, in addition to refuting or criticizing any detected assertions, may be designed or selected so as to promote the sponsoring brand and/or its products.

As an example, the application may detect a phrase or slogan such as “Come see Brand X for the best prices!” The application might look up this phrase in a database or other data store to find a corresponding response such as “Come see Brand A for even lower prices!”, and might display this response near or over the detected phrase or slogan. In this case, “Brand A” would be the sponsoring brand of the application 110, and Brand X would be a competitor brand.

The application 110 may also be configured to detect a product or brand logo within an image, and in response to display commentary that is relevant to the product or brand associated with the logo. In some cases, such commentary may be designed or selected to promote the sponsoring brand and/or its products, and in some cases the commentary may also relate to the product or brand associated with the logo. When the logo is that of a competitive product or brand, the commentary may be critical of that product or brand, or may state advantages of the sponsoring brand as opposed to the brand promoted by the advertisement. When the logo is that of the sponsoring brand, the commentary may be complimentary of the product or brand.

The application 110 may also be configured to detect other objects within an image, such as people, dogs, airplanes, devices, etc., and to display comments relating to the various detected objects. The comments may be general in nature or may be designed to promote the sponsoring brand and/or its products.

The application 110 may call upon various functional components 112 in order to detect items and characteristics that are portrayed by an image. The functional components 112 may be embedded within the application 110 or may be separate applications or services with which the application 110 communicates. For example, the functionality represented in FIG. 1 by a given functional component 112 may be a native part of the application 110. In some embodiments, a given functional component 112 may comprise a software module that is provided by a third party for use by or within the application 110. As another example, a given functional component 112 may comprise a remote service or software module that is provided by a third party and accessed through a wide-area network using network APIs or other means of communication. Various embodiments may include different combinations of the illustrated functional components 112, and may include other functional components for detection or recognition of items and characteristics not specifically described herein.

In the illustrated embodiment, the functional components include a text recognition component 112(a), a logo recognition component 112(b), a color detection component 112(c), an object recognition component 112(d), a face detection/recognition component 112(e), a mood recognition component 112(f), and a landmark recognition component 112(g). In some cases, functional components may also include an adult content detection component 114 that analyzes an image to determine whether adult content such as nudity, sexual content, explicit language, or depictions of violence are present in the image.

In operation, the application 110 provides a captured image to each of the functional components 112 for analysis. Each functional component 112 analyzes the image to detect or recognize a particular characteristic or type of item, and returns data corresponding to any detected characteristic or item. For example, the text recognition component 112(a) may return any recognized words, keywords, phrases, slogans, or other text that is recognized in the image. The logo recognition component 112(b) may return an identification of a brand and/or product associated with any detected logo. The color detection component 112(c) may return an indication of any predominant color within the image. The object recognition component 112(d) may return an identification of an object detected in the image. The face detection component 112(e) may return data indicating that a human face has been detected in the image, and in some cases may return data indicating the identity of the person whose face has been detected. The mood recognition component 112(f) may return data indicating the mood expressed by any human face detected in the image. The landmark recognition component 112(g) may return data identifying recognized landmarks and/or their locations. In addition, each component 112 may return the coordinates within the image at which the detected element was recognized or detected.

The data returned by each functional component 112 may comprise a text string corresponding to each detected element. For example, the text recognition component 112(a) may return the text of any slogan or phrase recognized in the image. The logo recognition component 112(b) may return the textual name of the product or brand represented by a recognized logo. The color detection component 112(c) may return the textual name of any detected color. The object recognition component 112(d) may return the textual name of any recognized object, such as “dog”, “car”, “face”, “child”, “tree,”, etc. The face detection/recognition component 112(e) may return the textual name of any person recognized within the image. The mood recognition component 112(f) may return a textual word or phrase corresponding to a mood or emotion, such as “mad, “sad”, etc. The landmark recognition component 112(g) may return the textual name of any geographical landmark recognized in the image, as well as the textual name of the location of the recognized landmark, such as “Bismarck, N.D.”.

For purposes of discussion, the textual results returned by the functional components 112 will be referred to herein as result strings. In response to analyzing a particular image, any one or more of the functional components may return one or more result strings. In response to analyzing an image, the adult content recognition component 114 may return a true/false indicator, indicating whether adult content has been detected within the image.

After analysis of the image by the functional components 112, the application 110 references a response table 116 to determine a response string that should be presented to the user of the device 100 for one or more of the result strings. Generally, the response table 116 enumerates any number of expected result strings and respectively corresponding response strings. When a result string is received from one of the functional components 112, the application 110 looks up the result string in the response table 116 and retrieves the corresponding response string from the response table 116.

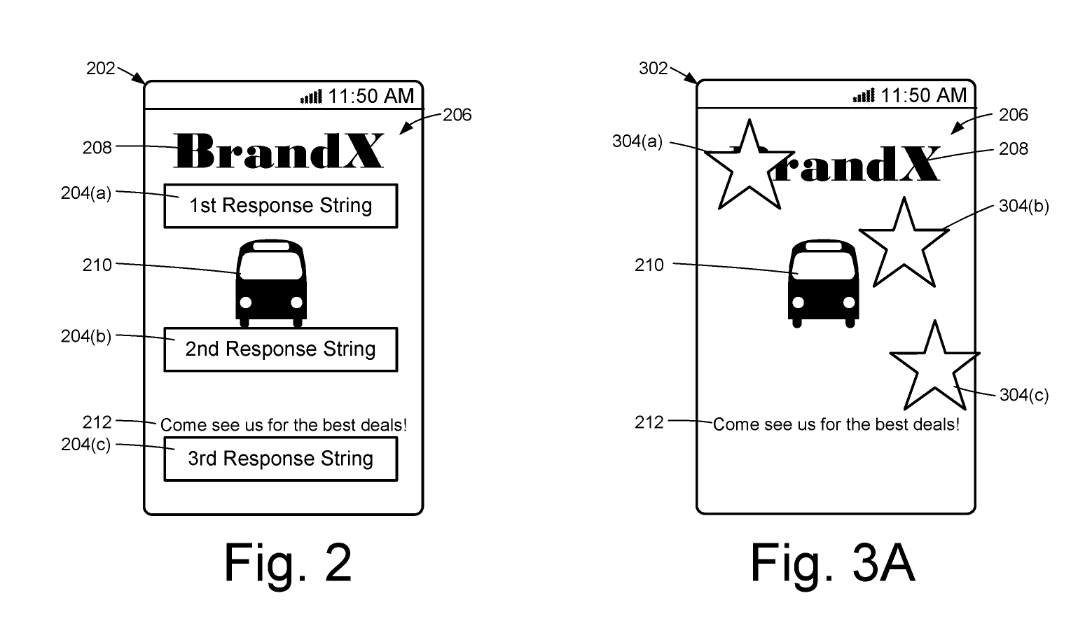

FIG. 2 illustrates an example GUI 202 in which several response strings 204 are displayed. The GUI 202 may be displayed on or within the display 102 of the device 100.

In the example of FIG. 2, the GUI 202 is showing an image 206 that has already been captured by the user. To capture an image, for example, the application 110 might present a capture screen within the GUI 202, in which a live view from a camera lens is shown. A capture button or control may also be shown within the GUI 202. The user points the device 100 and its camera at an advertisement so that the advertisement shows in the live view, and the user then touches the capture button. This causes the device 100 to capture the image 206, where the image 206 corresponds to the live view at the time the capture button was pressed. Alternatively, a user may select an image that has previously been captured or stored by the device 100. As another alternative, a user may supply or select an address of an external resource, such as a network or Internet URL (Uniform Resource Locator), that contains the image.

The image 206 is of an advertisement containing a logo 208, an object 210, which as an example is a bus, and a slogan 212. The application has submitted the image to the functional components 112, which have identified these elements. Specifically, the logo recognition component 112(b) has returned the result string “BrandX”; the object recognition component 112(d) has returned the result string “bus”; and the text recognition component 112(a) has returned the result string “Come see us for the best deals”.

In response to these result strings, the application 110 has looked up and displayed appropriate response strings 204. In this example, the response strings 204 are displayed in boxes overlying the image 206, and each response string 204 is placed near or overlying the corresponding result string: a response string 204(a) corresponds and relates to the logo 208; a response string 204(b) corresponds and relates to the object 210; and a response string 204(c) corresponds and relates to the slogan 212.

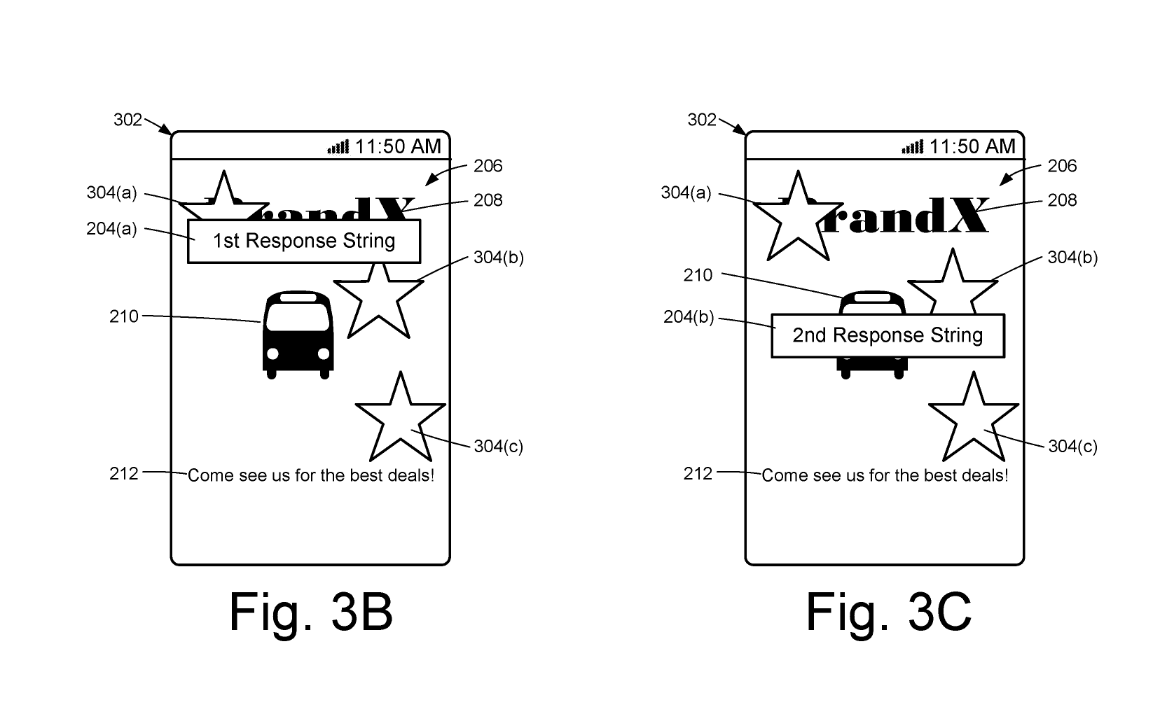

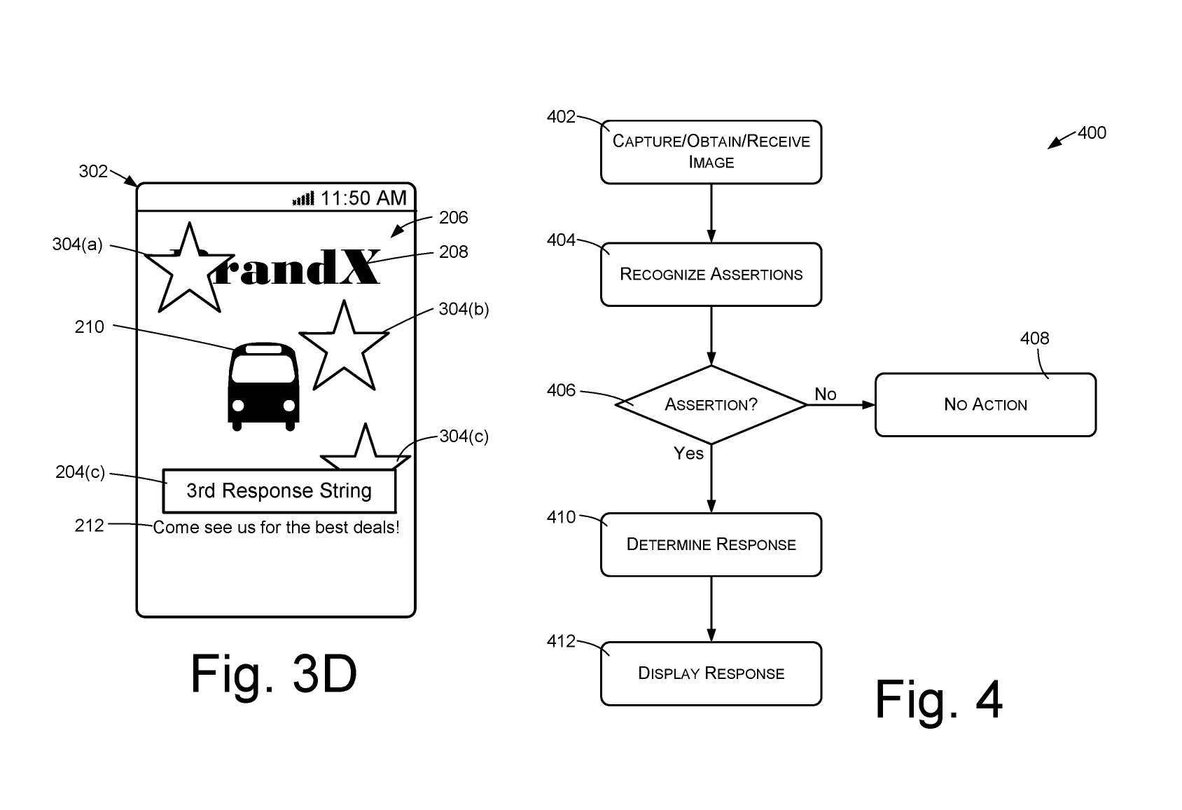

FIGS. 3A through 3C illustrate another example GUI 302 that may be used to show the image 206 and response strings 204 corresponding to elements of the image.

In FIG. 3A, rather than initially illustrating the response strings 204, after analyzing the image 206 one or more graphical, selectable controls 304 are shown near or overlaying respectively corresponding elements that have been detected in the image 206. In this example, a first selectable control 304(a) is shown over or near the logo 208, a second selectable control 304(b) is shown over or near the object 210, and a third selectable control is shown over or near the slogan 212.

In the illustrated example, the selectable controls 304 are stars, although the controls may be designed to have any desired appearance, and may in some cases comprise animated images.

Each selectable control 304 can be individually touched or otherwise selected to display a corresponding one of the response strings 204. In FIG. 3B, a first selectable control 304(a) has been selected by a user, with the result that the first response string 204(a) is displayed over or near the logo 208. In FIG. 3C, a second selectable control 304(b) has been selected by the user, resulting in the second response string 204(b) being displayed over or near the object 210. In FIG. 3D, a third selectable control 304(c) has been selected by the user, resulting in the third response string 204(c) being displayed over or near the object slogan 212.

FIG. 4 illustrates an example method 400 for presenting commentary or other information to a user in response to the user specifying an image of an advertisement for a product or brand. The image may be of any type of visual advertising material or any other type of graphical presentation that might relate to a brand or product, including printed advertisements as well as information and graphics shown on a computer display, a billboard, wall-mounted signage, packaging, etc. The method 400 can be performed in part by the device 100 and/or in part by one or more computer servers such as Internet servers or other network-based servers. In the context of FIG. 1, the method 400 may be performed by the application 110 and the text recognition component 112.

For purposes of discussion, it will be assumed that the advertisement is for a first brand and/or a product of the first brand, that the method 400 is being performed by an application or service that is sponsored by a second brand, and that the second brand is a brand competitor of the first brand and/or its products. The first brand will be referred to as the advertising brand, and the second brand will be referred to as the sponsoring brand.

An action 402 comprises capturing, receiving, or otherwise obtaining an image that has been designated by a user for analysis and commentary. The image may be of an advertisement that promotes the advertising brand and/or any of its products, for example. In certain embodiments, a user may designate an image by capturing the image using a camera of a mobile device. In other situations or embodiments, a user may designate an image by selecting from images that have previously been captured and that are stored on the device. As another example, a user may provide a network address, such as an Internet URL, from which the image can be retrieved. In some embodiments, the action 402 may include specifically instructing or guiding the user in capturing or otherwise specifying the image or its location.

An action 404 comprises analyzing the designated image or causing the image to be analyzed in order to recognize text within the image and to identify any phrases representing assertions regarding a product or brand. An assertion may be a statement regarding the quality, effectiveness, efficiency, cost, performance, etc. of the advertising brand or any of its products. The assertion may be a direct assertion, such as a statement that is phrased as a factual declaration, or an indirect assertion, such as a statement that is based on an assumed or implied fact. The following are examples of assertions:

“Shop here for savings.”

“World's best products!”

“We Care.”

“Large inventory.”

“Competitive prices!”

“No transaction fees!”etc.

The action 404 may comprise performing text recognition on the image, such as by providing the image to the text recognition component 112(a) of FIG. 1 for analysis and optical character recognition (OCR).

An action 406 comprises determining whether an assertion was recognized in the image. If not, no further action is taken, as shown by the block 408. In some embodiments, the action 406 may comprise determining whether any recognized words or phrases are listed in a lookup table or other database as being assertions for which responses can be provided.

If the image contains an assertion, such as a word or phrase that is listed in the response table 116, an action 410 is performed of determining a response to the assertion. For example, the response may comprise media that is responsive to the assertion or that relates to the assertion. In some cases, the response may comprise text that forms a statement or comment, where the statement or comment is critical of the assertion, questions the assertion, or refutes the assertion. For example, a textual response might state that the assertion is false, or might point out deceptions or inaccuracies in the assertion. In some cases, a response may point out problematic attributes, features, or aspects of the advertised product or brand, and/or might assert the superiority of the sponsoring brand. The response may also comprise a comparison in which the advertised product or brand is described or depicted unfavorably. In some cases, a response may be phrased sarcastically, such as a response of “Really?!!!” to suggest disbelief. Many other types of responses may be appropriate, depending on the market, the advertising and sponsoring brands, the product, etc. In some cases, rather than criticizing the assertion, the advertising brand, or the advertised product, the response may promote the sponsoring brand and/or a product of the sponsoring brand. In some cases, a promotional response such as this may be chosen such that it relates somehow to the assertion made in the advertisement, such as responding that the sponsoring brand or its product has superior qualities in an area that is implicated by the assertion.

In some cases or embodiments, the response may comprise any type of media resource, such as text that is shown by the mobile device, video that is played by the mobile device, audio that is played by the mobile device, graphics including animated graphics that are displayed by the mobile device, etc. In some embodiments, the response may comprise a combination of different media resources.

In some embodiments, the action 410 may comprises referencing a data store, such as a lookup table, to find one of multiple textual statements or other media resources that corresponds to the assertion, the advertising brand, or the advertised product. For example, such a data store may enumerate the text of multiple different assertions and may also enumerate corresponding text strings or other media to be used as responses.

An action 412 comprises displaying or otherwise presenting a media resource that relates to at least one of the detected assertions, to the product that is the subject of the advertisement shown by the image, and/or to the advertising brand, as determined by the action 410. The response may be presented in any appropriate manner In some cases, the response may be presented in conjunction with the image of the original advertisement such as shown in FIGS. 2, 3A, 3B, and 3C.

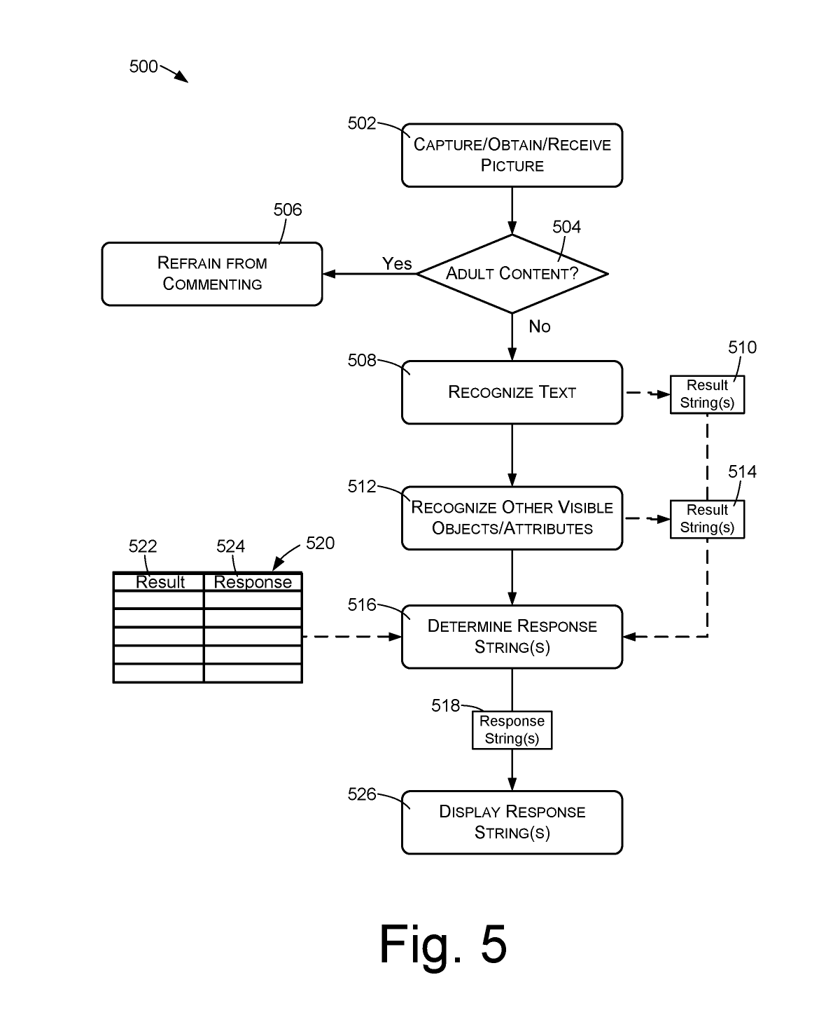

FIG. 5 illustrates an example method 500 for presenting commentary to a user in response to the user specifying an image of an advertisement for a product or brand. The method 500 can be performed in part by the device 100 and/or in part by one or more computer servers such as Internet servers or other network-based servers. In the context of FIG. 1, the method 500 may be performed by the application 110 and any one or more of the functional components 112.

An action 502 comprises capturing, receiving, or otherwise obtaining an image that has been designated by a user for analysis and commentary. The image may be of an advertisement that promotes a product or brand, for example. In certain embodiments, the action 502 may comprise instructing a user to capture an image using a camera of a mobile device. In other situations or embodiments, a user may designate an image by selecting from images that have previously been captured and that are stored on the device. As another example, a user may provide a network address, such as an Internet URL, from which the image can be retrieved. In some embodiments, the action 502 may include specifically instructing or guiding the user in capturing the image using a camera of a mobile device or in otherwise specifying an image or its location.

An action 504 comprises analyzing the image or causing the image to be analyzed to determine whether the image contains adult content, which in the described embodiment may be performed by the adult content recognition component 114. If the image is identified as containing adult content, an action 506 is performed, which comprises refraining from commenting or performing any type of brand promotion or criticism in conjunction with the image. Subsequent actions of the method 500 are performed when the image does not contain adult content.

An action 508 comprises performing text recognition on the image or causing text recognition to be performed on the image to recognize any words, keywords, phrases, slogans, names, etc. that might be depicted by the image. As an example, the action 508 may be performed by the text recognition component 112(a) of FIG. 1.

The action 508 produces result strings 510 corresponding respectively to each detected textual element. For example, each result string 510 may comprises a word, keyword, phrase, slogan, name, etc. that is found in the image.

An action 512 comprises analyzing the image or causing the image to be analyzed to recognize other visible objects and/or object attributes that are depicted by the image, such as logos, the brands or products represented by the logos, any occurring or predominant color in the image, animate and inanimate objects, faces, identities of people whose faces are detected, moods or emotions expressed by detected faces, landmarks, locations of landmarks, etc. In the environment shown in FIG. 1, the functional components 112(b) through 112(g) may be called upon to perform the action 512.

The action 512 produces result strings 514 corresponding respectively to each detected object or attribute. For example, each result string 514 may comprise a word or string identifying a detected object or attribute.

After the actions 508 and 512, an action 516 is performed, based on the result strings 510 and 514. The action 516 comprises determining one or more response strings 518 corresponding to the result strings 510 and 514. More specifically, the action 516 comprises referencing a lookup table 520 to find the response strings 518.

The lookup table 520 has a result column 522 and a response column 524. The rows of the result column 522 contain the textual result strings for which responses will be displayed. The corresponding rows of the response column 524 specify corresponding response text strings or other information that is to be presented in response to the result strings. For each result string identified for an image, the action 516 comprises finding the row of the table 520 that specifies the result string, and then retrieving the corresponding response string or other information from the same row.

In some embodiments, there may be multiple lookup tables 520, or the lookup table 520 may have multiple sections, and the tables or sections might correspond to different content categories. Content categories may comprise, as examples, brands, products, people such as celebrities that are likely to be in images, moods, colors, etc. The action 516 may first analyze the result strings 510 and 514 to determine whether any one of them corresponds to a particular category. After that, any other result strings may be looked up from the same category. In this manner, an particular object detected in an advertisement for Brand A may correspond to a result string that is different than the result string for the same object detected in a Brand B advertisement.

In some embodiments, the lookup table 520 may indicate multiple responses for any particular result string. In this case, the action 516 may comprise randomly selecting one of such result strings.

Furthermore, in addition to a response string, the lookup table 520 may have additional columns corresponding to different types of media resources or information that might be displayed in response to any given result string. For example, additional columns may specify graphics, headings, titles, video, audio, animations, and/or other resources that may be presented in response to various result strings.

After the action 516, an action 526 is performed of displaying the response strings 518, and more generally of presenting any media resources such as video, audio, graphics, etc. corresponding to the result strings 510 and 514 as specified by the lookup table 520. Response strings can be displayed as shown by FIGS. 2, 3A, 3B, and 3C, or in any other way depending on GUI implementation details.

In some cases, depending on the particular advertisement shown in the image, the action 512 may include causing the logo recognition component 112(b) to analyze the image, which may result in the identification of a product or brand that is represented by a detected logo in the image. The logo recognition component 112(b) may in these situations return a result string comprising the name of the product or brand, and the table 520 may indicate a result string to be displayed in conjunction with the image or logo.

Similarly, the action 512 may include may include causing the color detection component 112(c) to analyze the image, which may result in the identification of a product or brand that is associated with a color that is detected in the image. The color detection component 112(c) may in these situations return a result string comprising the color, and the table 520 may indicate a result string or other media resource that relates to the product or brand associated with the color.

The method 500 may result in various types of result strings being presented, not limited to responses to assertions or advertisements, depending upon which of the functional components 112 are used and depending on the image captured or specified by the user. Sometimes the user may submit an image of something other than an advertisement, such as a picture of an object or person, or a picture of the user's face. The action 512 may include causing any of the functional components 112 to be executed to detect and recognize different objects and characteristics, and the table 520 may be configured to have result strings for various types of detected objects in addition to advertising assertions. For example, the table 520 might list “dog” as a result string, and may specify a corresponding response string. If the object recognition component 112(d) detects a dog in the captured image, the response string or other media resource corresponding to “dog” can be displayed. The table 520 may include result strings for many different objects, and the respectively corresponding response strings may relate respectively to those objects. The response strings may be general, entertaining, and/or humorous in nature, may promote the sponsoring brand and/or its products, and/or may be critical of competing brands or products.

As another example, the table 520 might have a section corresponding to names of celebrities. If the face detection/recognition component 112(e) recognizes the face of a celebrity and reports the name of the celebrity, the response string corresponding to that celebrity name may be displayed. Similarly, the mood recognition component 112(f) may report a detected mood of a face detected in the image, or the landmark recognition component 112 may report the location of a detected landmark in the image, and a corresponding result string may be located from the table 520 and displayed. These results strings may be simply entertaining or informative, or may relate to product/brand promotion.

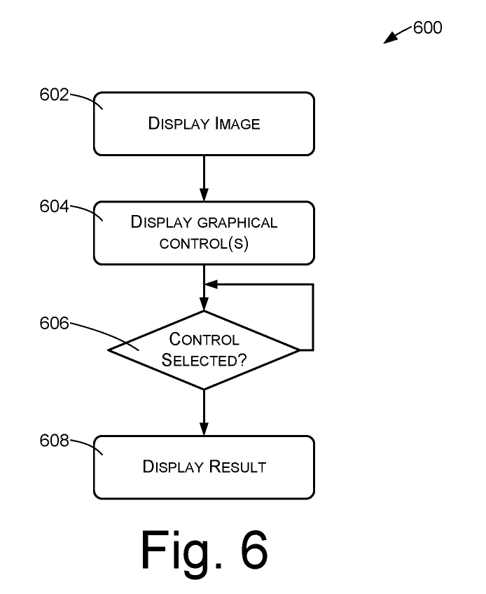

FIG. 6 illustrates an example method 600 of presenting one or more responses, in accordance with the example of FIG. 3A, 3B, and 3C. An action 602 comprises displaying the captured image on a display of a mobile device. An action 604 comprises displaying graphical controls near or over the image at locations corresponding to assertions that have been detected in the image. An action 606 comprises detecting selection of one of the graphical controls. If a control is selected, an action 608 is performed of displaying a response to the assertion near which the selected graphical control is displayed. As already described, the response may comprise any type of media resource, including text, graphics, audio, video, etc.

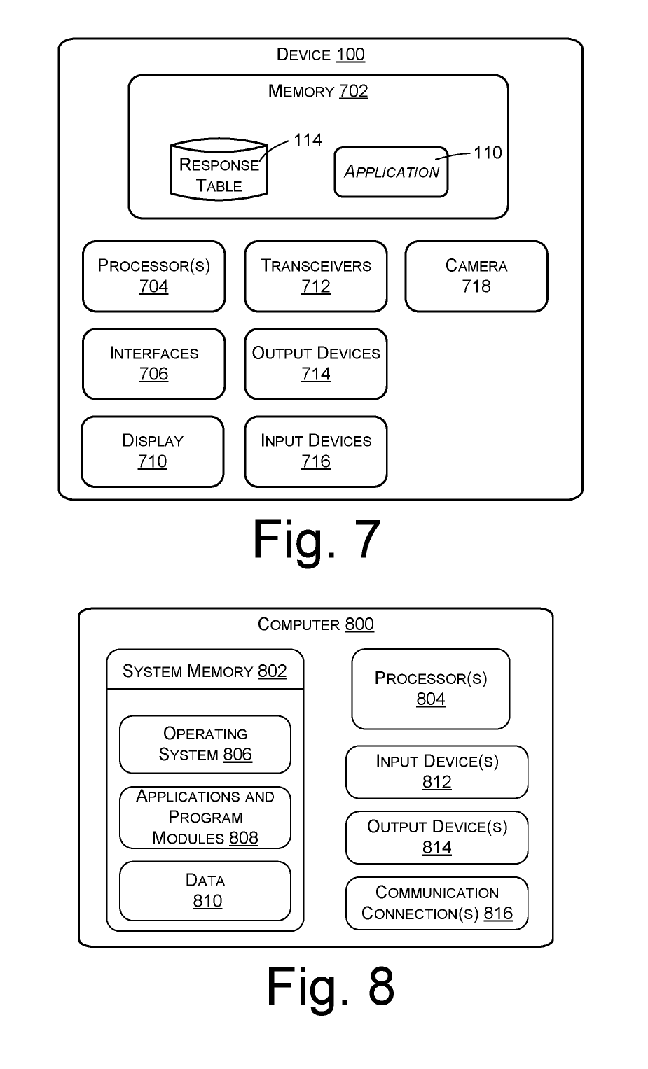

FIG. 7 illustrates an example of the mobile device 100 that may be used in conjunction with the techniques described herein. The device 100 may include memory 702 and a processor 704. The memory 702 may include both volatile memory and non-volatile memory. The memory 702 can also be described as non-transitory computer-readable media or machine-readable storage memory, and may include removable and non-removable media implemented in any method or technology for storage of information, such as computer executable instructions, data structures, program modules, or other data. Additionally, in some embodiments the memory 702 may include a SIM (subscriber identity module), which is a removable smart card used to identify a user of the device 100 to a service provider network.

The memory 702 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information. The memory 702 may in some cases include storage media used to transfer or distribute instructions, applications, and/or data. In some cases, the memory 702 may include data storage that is accessed remotely, such as network-attached storage that the device 100 accesses over some type of data communications network.

The memory 702 stores one or more sets of instructions (e.g., software) such as a computer-executable program that embodies operating logic for implementing and/or performing any one or more of the methodologies or functions described herein. The instructions may also reside at least partially within the processor 704 during execution thereof by the device 100.

Generally, the instructions stored in the computer-readable storage media may include various applications, an operating system (OS), and associated data. In particular, the application 110 or parts of the application 110 may be stored in the memory 702 for execution by the processor 704. In some embodiments, the response table 116 may be stored in the memory 702. In some embodiments, any one or more of the functional components 112 may be stored in the memory 702.

In some embodiments, the processor(s) 704 is a central processing unit (CPU), a graphics processing unit (GPU), both CPU and GPU, or other processing unit or component known in the art. Furthermore, the processor(s) 704 may include any number of processors and/or processing cores. The processor(s) 704 is configured to retrieve and execute instructions from the memory 702, such as instructions of the application 110.

The device 100 may have interfaces 706, which may comprise any sort of interfaces known in the art. The interfaces 706 may include any one or more of an Ethernet interface, wireless local-area network (WLAN) interface, a near field interface, a DECT chipset, or an interface for an RJ-11 or RJ-45 port. A wireless LAN interface can include a Wi-Fi interface or a Wi-Max interface, or a Bluetooth interface that performs the function of transmitting and receiving wireless communications using, for example, the IEEE 802.11, 802.16 and/or 802.20 standards. The near field interface can include a Bluetooth® interface or radio frequency identifier (RFID) for transmitting and receiving near field radio communications via a near field antenna. For example, the near field interface may be used for functions, as is known in the art, such as communicating directly with nearby devices that are also, for instance, Bluetooth® or RFID enabled.

The device 100 may have a display 710, which may comprise a liquid crystal display or any other type of display commonly used in telemobile devices or other portable devices. For example, the display 710 may be a touch-sensitive display screen, which may also act as an input device or keypad, such as for providing a soft-key keyboard, navigation buttons, or the like.

The device 100 may have transceivers 712, which may include any sort of transceivers known in the art. For example, the transceivers 712 may include radios and/or radio transceivers and interfaces that perform the function of transmitting and receiving radio frequency communications via an antenna, through a cellular communication network of a wireless data provider. The radio interfaces facilitate wireless connectivity between the device 100 and various cell towers, base stations and/or access points.

The device 100 may have output devices 714, which may include any sort of output devices known in the art, such as a display (already described as display 710), speakers, a vibrating mechanism, or a tactile feedback mechanism. The output devices 714 also include ports for one or more peripheral devices, such as headphones, peripheral speakers, or a peripheral display.

The device 100 may have input devices 716, which may include any sort of input devices known in the art. For example, the input devices 716 may include a microphone, a keyboard/keypad, or a touch-sensitive display (such as the touch-sensitive display screen described above). A keyboard/keypad may be a push button numeric dialing pad (such as on a typical telemobile device), a multi-key keyboard (such as a conventional QWERTY keyboard), or one or more other types of keys or buttons, and may also include a joystick-like controller and/or designated navigation buttons, or the like.

The device 100 may also have a camera 718. The camera may include an imaging sensor and associated lens that allows the device 100 to capture images of the user's environment, including pictures of advertisements. Note that in some cases, such images may comprise frames of video that is obtained or captured by the device 100 and its camera 718.

FIG. 8 is a block diagram of an illustrative computer 800, one or more of which may be used to implement the various components described herein, such as for example the application 110 or parts of the application 110, as well as any one or more of the functional components 112.

The computer 800 may include memory 802 and a processor(s) 804. The memory 802 may include both volatile memory and non-volatile memory. The memory 802 can also be described as non-transitory computer-readable storage media or machine-readable memory, and may include removable and non-removable media implemented in any method or technology for storage of information, such as computer executable instructions, data structures, program modules, or other data.

The memory 802 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information. The memory 802 may in some cases include storage media used to transfer or distribute instructions, applications, and/or data. In some cases, the memory 802 may include data storage that is accessed remotely, such as network-attached storage that the computer 800 accesses over some type of data communications network.

The memory 802 stores one or more sets of instructions (e.g., software) such as a computer-executable program that embodies operating logic for implementing and/or performing any one or more of the methodologies or functions described herein. The instructions may also reside at least partially within the processor 804 during execution thereof by the computer 800.

Generally, the instructions stored in the computer-readable storage media may include an operating system 806, various applications and program module 808, and various types of data 810. In particular, the application 110 or parts of the application 110 may be stored in the memory 802 for execution by the processor 804. In some embodiments, the response table 116 may be stored in the memory 802 as part of the data 810. In some embodiments, any one or more of the functional components 112 may be stored in the memory 802 for execution by the processor 804.

In some embodiments, the processor(s) 804 is a central processing unit (CPU), a graphics processing unit (GPU), both CPU and GPU, or other processing unit or component known in the art. Furthermore, the processor(s) 804 may include any number of processors and/or processing cores, and may include virtual processors, computers, or cores. The processor(s) 804 is configured to retrieve and execute instructions from the memory 802, such as instructions of the application 110 and/or instructions of any of the functional components 112.

The computer 800 may also have input device(s) 812 such as a keyboard, a mouse, a touch-sensitive display, voice input device, etc. Output device(s) 814 such as a display, speakers, a printer, etc. may also be included. The computer 800 may also contain communication connections 816 that allow the device to communicate with other computing devices. For example, the communication connections 816 may include network adapters such as an Ethernet adapter and/or a Wi-Fi adapter.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
obtaining a first image that has been designated by a user;
analyzing the first image to identify an assertion made within the first image regarding at least one of a product or a brand;
determining a response to the assertion; and
providing the response for presentation to the user.

2. The method of claim 1, wherein the response promotes a brand competitor of at least one of the product or the brand.

3. The method of claim 1, wherein obtaining the first image comprises capturing the first image using a camera of a mobile device.

4. The method of claim 1, further comprising:
displaying the first image on a graphical user interface of a device;
displaying a graphical control over the first image at a location of the assertion within the first image;
in response to selection of the graphical control by the user, displaying the response.

5. The method of claim 1, wherein the response comprises at least one of (a) text; (b) graphics; (c) audio; or (d) video.

6. The method of claim 1, further comprising:
obtaining a second image that has been designated by the user;
analyzing the second image to determine that the second image contains a color that is associated with a product or brand; and
presenting information relating to the product or brand.

7. The method of claim 1, further comprising:
obtaining a second image that has been designated by the user;
analyzing the second image to determine that the second image contains adult content; and
refraining from brand promotion in conjunction with the second image.

8. The method of claim 1, further comprising:
obtaining a second image that has been designated by the user;
analyzing the second image to recognize an object within the second image;
determining information that relates to the object; and
providing the information for presentation to the user.

9. The method of claim 8, wherein:
the object comprises a logo;
the method further comprises determining a brand represented by the logo; and
the information relates to the brand represented by the logo.

10. The method of claim 8, wherein:
the object comprises a human face;
the method further comprises analyzing the second image to detect a mood that is expressed by the human face; and
the information relates to the mood expressed by the human face.

11. The method of claim 8, wherein:
the object comprises a person;
the method further comprises analyzing the second image to determine an identity of the person; and
the information relates to the identity of the person.

12. One or more non-transitory computer-readable media storing computer-executable instructions that, when executed by one or more processors, cause the one or more processors to perform actions comprising:
instructing a user of a mobile device to capture a first image using a camera of the mobile device, wherein the first image promotes a product or brand;
causing the first image to be analyzed to:
(a) recognize text within the first image;
(b) identify, in the text, a phrase representing an assertion regarding the product or brand; and
(c) identifying a first media resource that responds to the assertion; and
presenting the first media resource to the user.

13. The one or more non-transitory computer-readable media of claim 12, wherein the first media resource promotes a brand competitor of the product or brand.

14. The one or more non-transitory computer-readable media of claim 12, wherein the first media resource comprises at least one of (a) text that is displayed by the mobile device; (b) graphics that are displayed by the mobile device; (c) audio that is played by the mobile device; or (d) video that is played by the mobile device.

15. The one or more non-transitory computer-readable media of claim 12, the actions further comprising:
instructing the user to capture a second image using the camera of the mobile device;
causing the second image to be analyzed to (a) recognize a color within the second image, (b) identify a product or brand associated with the color, and (c) determine a second media resource that relates to the product or brand; and
presenting the second media resource to the user.

16. The one or more non-transitory computer-readable media of claim 12, the actions further comprising:
instructing the user to capture a second image using the camera of the mobile device;
causing the second image to be analyzed to (a) recognize an object within the second image and (b) determine a second media resource that relates to the object; and
presenting the second media resource to the user.

17. A mobile device comprising:
one or more processors;
a camera;
a display;
one or more non-transitory computer-readable media storing computer-executable instructions that, when executed on the one or more processors, cause the one or more processors to perform actions comprising:
capturing a first image using the camera, wherein the first image promotes at least one of a product or a brand;
causing the first image to be analyzed to identify an assertion made within the first image regarding at least one of the product or the brand; and
presenting a first media resource that relates to at least one of the assertion, the product, or the brand.

18. The mobile device of claim 17, wherein the first media resource promotes a brand competitor of at least one of the product or the brand.

19. The mobile device of claim 17, wherein presenting the first media resource comprises:
displaying the first image on the display;
displaying a graphical control over the first image at a location of the assertion within the first image;
detecting selection of the graphical control; and
displaying the first media resource on the display in response to detecting selection of the graphical control.

20. The mobile device of claim 17, wherein the first media resource comprises at least one of (a) text; (b) graphics; (c) audio; or (d) video.
